(19) United States
(12) Patent Application Publication
(10) Pub. No.: US 2002/0016797 A1
(43) Pub. Date: Feb. 7, 2002

(54) Network based interviewing and processing system

(76) Inventor: Seda Taysi, San Francisco, CA (US)

Correspondence Address: OPPENHEIMER WOLFF & DONNELLY, P. O. BOX 10356, PALO ALTO, CA, 94303, US

(21) Appl. No.: 09/872,169

(22) Filed: Jun. 1, 2001

Related U.S. Application Data
(63) Continuation-in-part of application No. 09/873,119, filed on May 31, 2001.
(60) Provisional application No. 60/209,815, filed on Jun. 6, 2000.

(51) Int. Cl. G06F 7/00

(52) U.S. Cl. 707/508; 707/100

(57) ABSTRACT

A method and apparatus for creating an online questionnaire, accessible only at a secure network site. The present invention discloses using such a questionnaire for collecting data necessary for the documenting and calculating R&D tax credit. Tools are provided to assist administrative functions such as setting up the due dates of an interview campaign, sending email notices and creating tracking and analysis reports regarding the questionnaire. Interviewees may access online help in the form of instructions, definitions, samples and incentives for timely completion of the questionnaire.

### CROSS REFERENCE TO RELATED APPLICATION:

The present application claims the benefit of co-pending U.S. provisional application No. entitled “Method and Apparatus for Network-based Tax Data Processing” serial No. 60/209,815, filed Jun. 1, 2000, and incorporated herein by reference.

### BACKGROUND OF THE PRESENT INVENTION

1. Field of the Invention

The present invention relates generally to computer network based methods and apparatus for retrieving and processing application-specific data, and more particularly to Internet enabled tax calculation and/or compliance systems.

2. Background Art

The Research & Development (R&D) tax credit was enacted to address the problem of U.S. under-investment in research activities. To spur technological advancement, Congress enacted a twenty percent credit to be applied against any increases in R&D expenses measured from an average based on a prior period. As it will be appreciated, credits are the most significant type of tax benefit a taxpayer can receive. This is because they represent a dollar for dollar reduction against tax liability as compared to deductions, which reduce the taxable income upon which the tax rate is measured.

To be eligible for the R&D tax credit, the company must be engaged with “qualified research expenses.” Qualified research expenses are defined as expenditures incurred to develop a new product, a product enhancement, or a new or improved process of experimentation that occur within a department or business activity. These expenditures can typically be divided into two classes: 1) support research, defined as activities that are performed in direct support of qualifying R&D; and 2) pure or direct research which is a more traditional type of R&D that involves the discovery or development of new products or concepts.

Research of either class qualifies if it meets the following four part test, which is as follows. First, the R&D activities must be intended to discover information that would eliminate uncertainty concerning the development or improvement of a product or process. Second, the R&D activities must involve a process of evaluating alternatives designed to achieve a result where the means of achieving that result were uncertain at the outset. Third, the principles of the activities must be hard science in nature. Fourth, the outcome of the research activities must be in the pursuit of developing new features and functionality.

As will be appreciated in the foregoing discussion, an initial requirement for obtaining the R&D tax credit is to obtain data from the requesting company which supports the requirements of the four part test. The traditional method of compiling the data needed in computing the R&D tax credit has been to personally conduct interviews with each employee involved in research and development as well as collecting supporting documents The data obtained from the individual interviews were compiled and used to calculate the amount of activities conducted by each employee that might be subject to the R&D tax credit. Unfortunately, especially in larger companies, the interviewing process tends to be cumbersome, time consuming and prone to errors. Therefore, an improved method and apparatus is needed that would unable the user to automate the interviewing process for the R&D tax credit and to help organize and compile the data collected in the interviews.

Network based systems, e.g. Internet based systems, have been used to gather data using, for example, questionnaires or surveys. The advantage of network based systems is their efficient and relatively low cost in obtaining data from one or more interviewees. However, network-based systems of the prior art are typically limited to simple questionnaires, allowing one or more interviewees to fill in response boxes, check a response from a list of responses, etc. This systems are not suitable for organizing and analyzing data received collected using a questionnaire. Powerful tools in data processing and management are necessary to allow satisfactory data retrieval management and processing such as that required for companies in obtaining data necessary for the R&D tax credit.

Some prior applications have used a network based system and communication methods such as email to transmit and receive questionnaires from interviewees. However, such systems do not offer the security necessary for collecting information that is sensitive nature, such as financial information using a questionnaire. Furthermore, because of the distributed nature of such a system, management tools would not be available for allowing the tracking of the progress of the completion of a questionnaire. The administrator can not access the questionnaire in order to verify the accuracy of the inputted data, until the questionnaire has been completed and transmitted back to the administrator. Such a system lacks the flexibility of an integrated system that could allow users to access questionnaires, receive help in completing the questionnaire and at the same time allow an administrator to monitor the progress and help in the completion of the questionnaire.

Therefore, what the prior art lacks is a network-based interviewing method and apparatus that automates the interviewing process for complex applications such as applications for the R&D tax credit using interactive questionnaires and provides with management tools for organizing and analyzing the information provided via the network-based interviews.

### SUMMARY OF THE PRESENT INVENTION

In general terms, the present invention relates to a network based method and apparatus for interviewing a large group of people and tools for organizing and processing the resulting data. The method and apparatus of the present invention allows for the creation of specific questionnaires or “surveys” suitable for a particular purpose, placing of the questionnaires on specifically created secure sites and limiting access to the questionnaires using passwords. The data is stored and then processed utilizing a variety of tools.

In another embodiment of the present invention, a network based method and apparatus is disclosed for interviewing people for the purpose of gathering data for compiling R&D tax credit information. The method and apparatus of the present invention provides tools to create an appropriate questionnaire and tools to organize and analyze data from the questionnaire for the purpose of obtaining R&D tax credit.

In yet another embodiment of the present invention, a method and apparatus is disclosed providing various management tools for an administrator to manage automated communication and notification with the selected interviewees. The invention also includes tools to add or remove personnel and departments from the list of the interviewees, to access the questionnaires simultaneously as they are being completed, and to create reports tracking the progress of the completion of the questionnaire.

In another embodiment of the present invention, the interviewing system provides tools for helping the interviewee complete the questionnaire by providing instructions, samples of a completed questionnaire, definitions of the terms used in the questionnaire, live help via direct email, incentive for completing the questionnaire on time, and the opportunity to examine the completed questionnaire and correct any mistakes before final submission of the questionnaire.

These and other advantages of the present invention will become apparent to those skilled in the art upon a reading of the following descriptions and study of the various figures of the drawings.

### BRIEF DESCRIPTION OF THE DRAWINGS

FIG. 1 is a block diagram of a network-based interviewing an processing system in accordance with the present invention;

FIG. 2 illustrates an exemplary data flow within the system of FIG. 1;

FIG. 3 is a flow diagram illustrating the operation of the interviewer module of FIG. 1;

FIG. 4 is a flow diagram illustrating certain activities of a system administrator;

FIG. 4a is a “screen shot” from the display of a computer system of an illustrative administrator interface “web page” in accordance with the present invention;

FIG. 4b is a screen shot illustrating additional features of an administrator web page;

FIG. 4c is a screen shot illustrating still more features an administrator web page;

FIG. 4d is a screen shot illustrating a user interface for selecting options for tracking reports;

FIG. 4e is a screen shot of a user interface displaying a summary R&D report organized by department;

FIG. 4f is a screen shot of the a interface displaying a detail R&D report organized by state;

FIG. 4g is a screen shot of a user interface displaying an R&D Questionnaire status report;

FIG. 5 is a flow chart of the activities or process 129 of the user through the interview process;

FIG. 5a is a screen shot of the start of an interviewer web page and a portion of a network-based questionnaire in accordance with the present invention;

FIG. 5b is a screen shot of an additional portion of the questionnaire;

FIG. 5c is a screen shot of the user interface illustrating a user matrix for a user who is not a department manager;

FIG. 5e is a screen shot of a user interface illustrating a matrix for a user who is a department manager; and

FIG. 6 is a screen shot of an exemplary administrator interface at a highest administrator level.

### DETAILED DESCRIPTION OF THE PREFERRED EMBODIMENT(S)

The present invention discloses a method and apparatus (“system”) for collecting data by conducting network based interviews and providing tools for organizing, manipulating and processing the resulting data. In order to describe specific applications of the present invention, an embodiment thereof is described below as applied to collecting necessary data for computing Research & Development (R&D) tax credit. However, it will be appreciated by those skilled in the art that the network based interviewing and processing system described herein may be applicable to a variety of data gathering and processing tasks for complex applications, e.g. regulatory, scientific, and compliance applications.

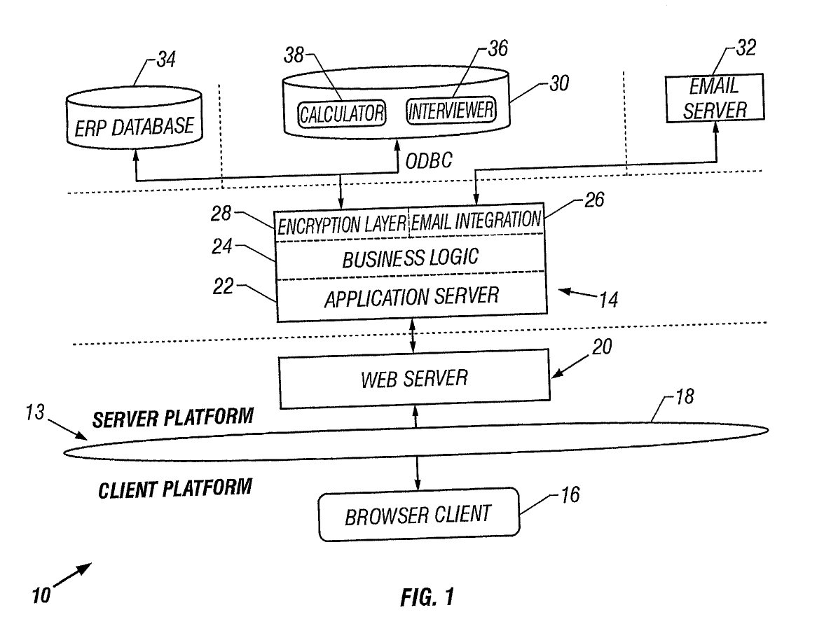

FIG. 1 is a block diagram of a network-based interviewing and processing system in accordance with the present invention. In this embodiment, a system 10 includes two conceptual portions: a client platform 12 by which a user can access the system 10, and a server platform 13 implementing many of the processes of the present invention. The user preferably interfaces with the system 10 through a wide area or “global” network such as the Internet 18, typically using a web browser 16

As used herein, the “user” is a person who utilizes the interviewing and processing capabilities of the network-based system of the present invention. The user can be either an administrator (who administers the system) or an interviewee, who provides data in response to questionnaires. A “system administrator” is typically a person who sets up the high level functionality of the system and is not specifically considered to be a user, and defined herein. The system administrator is therefore often a representative of the system provider, or a consultant specifically trained for this task, although the user can also be a system administrator if sufficiently trained.

It should be noted that the Internet has been given as an example of a network used to support the networked-based system of the present invention. As will be appreciated by those skilled in the art, the Internet is an example of wide area or “global” network which operates by sending data packets over a distributed network of computers, often utilizing a standard protocol know as TCIP/IP. There are other networks that also use the TCIP/IP protocol, such as Intranets (private Internet-compatible networks), as well as proprietary network systems. It will therefore be appreciated that while the network-based system of the present invention will be discussed in terms of the Internet, that it also applies to other types of networks and to networks utilizing other types of protocols.

In the present example, access to the system is preferably made via the Internet 18. Most standard user web browsers on the market today use Secured Socket Layer (SSL) security, and allow secure access and down loading of the web pages the user is viewing. Preferably, the web server 20 is also protected by a firewall 19 from the Internet 18 to reduce the chance for a security breach. Firewalls can be software running on the web server, running on another computer, or can be a dedicated firewall module. The security system of the present invention may be based on IP address protection and/or password protection, or both.

A system administrator is preferably granted access to the web server to administer the overall system 10. For example, the system administrator will be able to see which users and interviewees may have access to the system 10.

Web server 20 illustrates an instance of the server platform 13. As will be appreciated by those skilled in the art, web server 20 is typically a computer or workstation (“machine”) provided with web server utilities, tools, and applications. Physically, the web server 20 can be implemented on one or more machines.

In a preferred embodiment of the present invention, a Microsoft Window Internet Information Server (IIS) platform is used as the web server platform. One or more software applications, data structures, etc. which implement the present invention may be supported by this web server platform. Internet Information Server (IIS) is a group of Internet server platforms (including a Web or Hyper Text Transfer Protocol (HTTP) server and a File Transfer Protocol server) with additional capabilities for Microsoft's® Windows NT™ and Windows 2000™ server operating systems. It would be appreciated by one skilled in the art, that other platforms such as LinUX™, Solaris™ or Apache™ may also be selected for use as the web server platform.

The web server 20 communicates with a host application server 14 running on Microsoft® NT™ server in this example. It should be apparent to one skilled in the art that other server platforms may be used in place of the Microsoft® NT™. The application server 14 is actually comprised of four sub components: an application sever control logic 22, a business logic 24, an email integration layer 26 interfacing with the email server 32, and an encryption layer 28 encrypting the collected data before storing them on the Relational DataBase Management System (RDBMS) 30.

The application server 14 and its various components such as the email integration layer and the encryption layer 28 communicate with an RDBMS server 30, an email server 32 and Enterprise Resource Planning Database (ERP) 34. The response data from the questionnaire is collected, encrypted for additional security and then stored in the RDBMS database. An ODBC driver is used in this example to access the RDBMS database 30. It should apparent to one skilled in the art that other database drivers or other types of databases may be used to implement the features of the present invention. It will be appreciated by those skilled in the art, that these databases and servers may reside on the same physical system (“machine”) or be distributed over a network of servers.

ColdFusion™ is preferably used to implement the business logic engine 24. ColdFusion™ is a scripting language created by Allaire® corporation based in Newton, Mass. In one embodiment of the present invention, ColdFusion™ is be used to implement the business logic including the data base queries used access the RDBMS 30 database. It would be appreciated by one skilled in the art, that other scripting languages or programming languages such as Java™, or C++™ may be used to implement the business logic module 24 and application server platform 22 of the present invention. The business logic provides the tools to process the response data generated from the questionnaire by organizing and formatting the data in each data field of the questionnaire and saving them to the RDBMS database 30.

In a current embodiment of the present invention, the database server 30 is implemented on a Microsoft® SQL™ platform. However, it should be apparent to those skilled in the art that other commercially available platforms such Oracle™ may be used to implement the database module 30. The RDBMS database 30 includes an area corresponding to the interviewer generated data 36 in response to the questionnaires and may include a calculator generated data 38. Tax data calculation may be performed by a standalone calculator module or by using standard off the shelf spreadsheets or other calculator programs. For example, the calculator can simply include an Excel™ type spreadsheet programmed to organize and/or process retrieved data, or can be a custom designed integrated module for calculating, for example, a companies R&D tax credit. In the present example the RDBMS database 30 must include the capability to track an employee's movement from department to department, while maintaining a separate R&D activity data file for that employee under each department he or she has been a part of.

Although in a preferred embodiment of the present invention the components comprising the interviewing system are distributed over a wide area network and the user accesses the system using a network such as the Internet, it would be appreciated by one skilled in the art, that the present invention may also be implemented in an integrated system whereby all the components reside on either a local network or even a single stand alone computer internally configured in a networked fashion. For example, a computer running VMWare™ from VMWare® Inc of Palo Alto, Calif., can emulate a number of computers coupled together as a network.

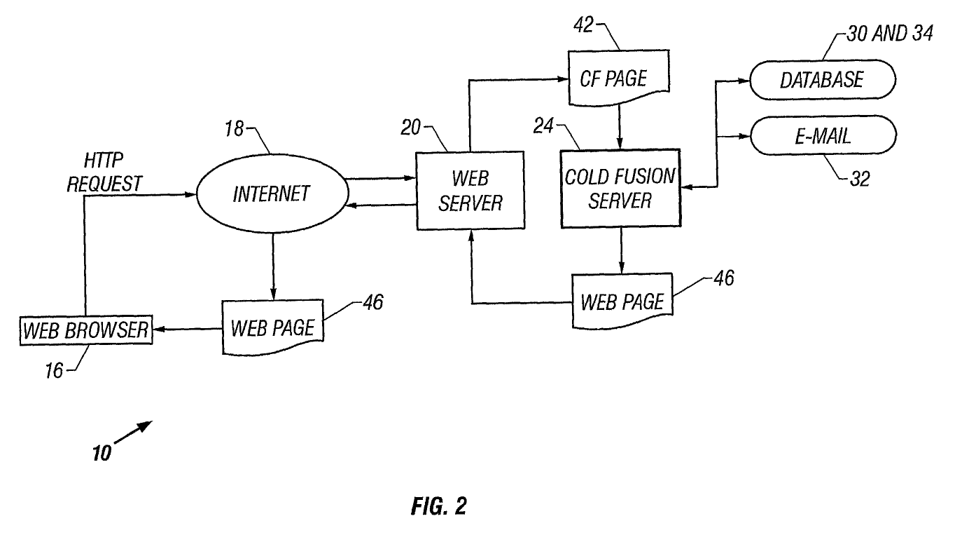

FIG. 2 is an illustrative representation of the data flow within the present invention. As illustrated in FIG. 2, a user preferably accesses the network-based interviewing system 10 using a web browser 16 which sends an HTTP request through the Internet 18 to the web server 20. The web server 20 recognizes the HTTP request as a ColdFusion™ page 42, and therefore directs the request to the Business Logic module 24, which is implement in ColdFusion™.

The business logic 24 processes the HTTP request and generates a web page 46 that is transmitted through the Internet to the user or interviewee via the server 20. The user's web browser displays web page 46 (i.e. the image of web page 46 as transmitted over the Internet). The business logic 24 also transmits data to email server 32 via the email integration module 26 and to databases 30 and 34 via the encryption layer 28.

As mentioned previously, and as further noted here, the various component modules for implementing the web server 20 are commercially available from a variety of vendors. For example, a variety of vendors provide application servers, encryption layer modules, and email integration modules. The primary proprietary portions of the present invention include the business logic module 24, and the proprietary database structures implemented in the ERP and RDBMS databases which provide the rich functionality of the present invention.

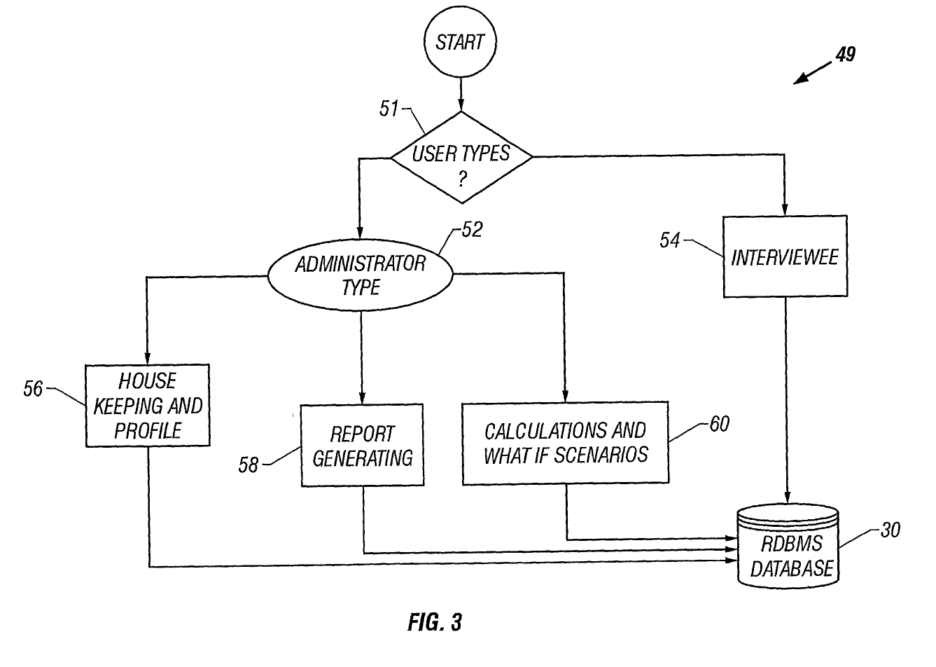

FIG. 3 is an illustration of the functionality of the interviewer module 36. The interviewer module supports two types of users. A first type of user is an administrator who can perform administrative functions, and a second type of user is an interviewee responding to a questionnaire or otherwise providing data to the system. Each type of user accesses the appropriate web site by using the corresponding Uniform Resource Locator (URL) address for that site. Preferably, a user has to logon at the start of its session. For increased security, the access to the web site may be restricted to the known IP addresses.

A process 49 performed by the interviewer module 36 (FIG. 1) first determines the user type at in a decision operation 51. This is typically accomplished by logging in as either an administrator or an interviewee, with appropriate passwords. If the user is an administrator, the type of administrative function is determined in a decision operation 52. Preferably included among the administrative functions are the housekeeping and profile function 56, the report generating function 58, and the calculation and “what if” scenarios 60. The output of each of these functions are stored in the RDBMS database 30. On the other hand, if the user is an interviewee, process control is passed to a survey module 54 for the administration of an interactive survey. The output of the survey module 54 is likewise stored in the RDBMS database 30.

As noted above, an administrator user preferably can perform a number of administrative functions. For example, the administrator may do housekeeping tasks (56) such as: adding a year feature, department and employee management, and interview related email management. The administrator may also generate various types of reports (58) related to the interviews conducted such as, for example, generating tracking reports, and sorting and processing interview results by generating matrix reports. Finally, the administrator may have the capability of processing the data, such as by performing calculations and “what if” scenarios (60) based on the results of the interviews conducted.

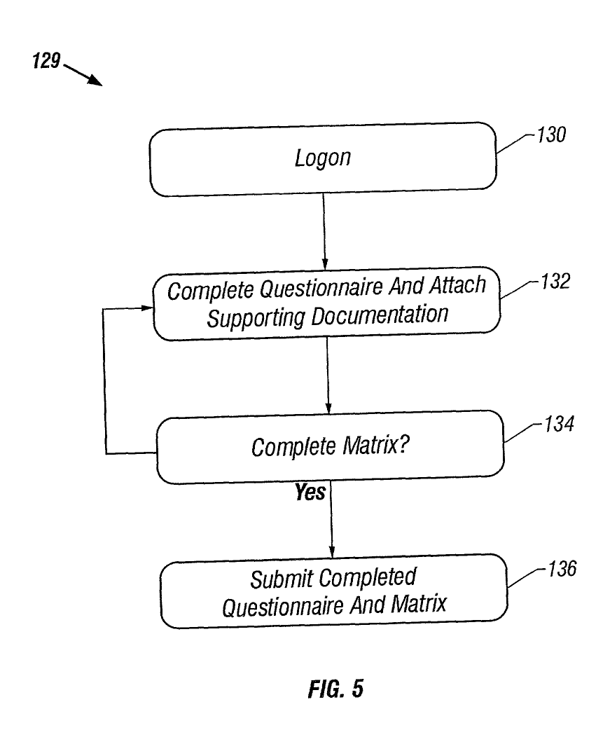

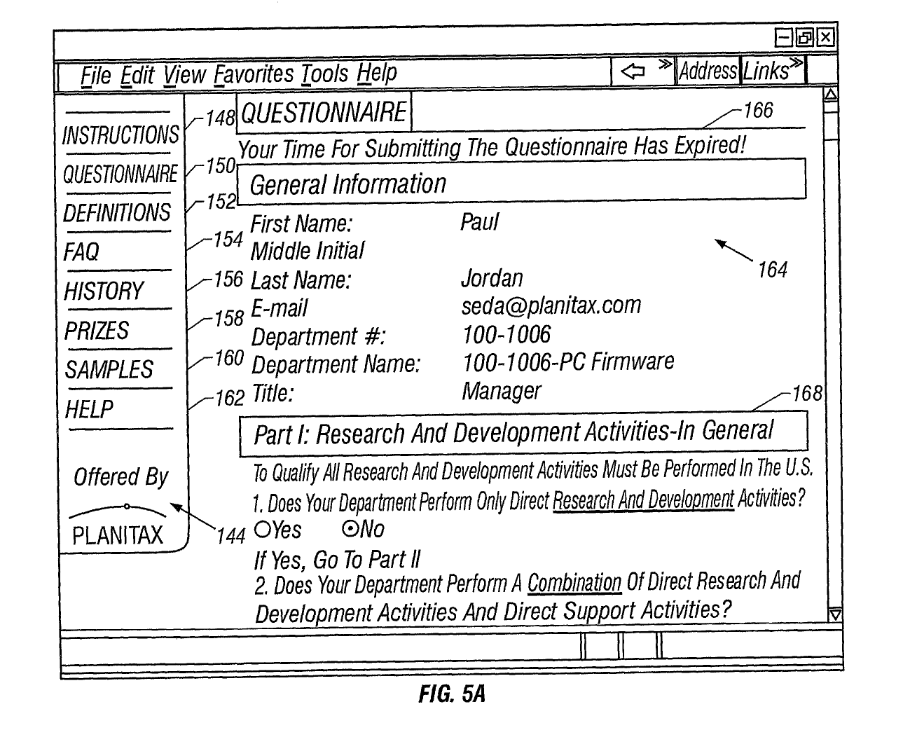

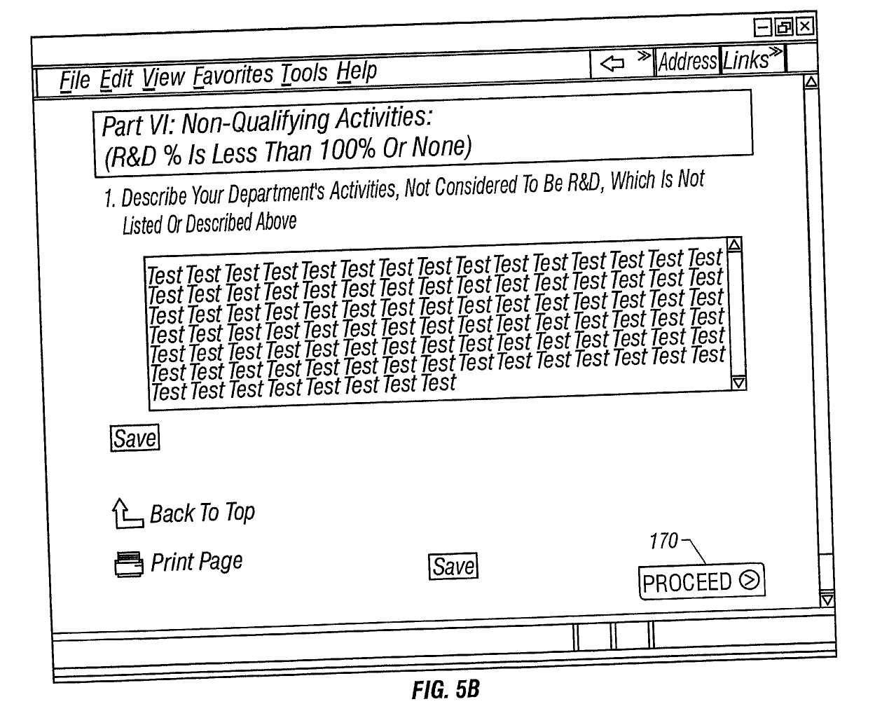

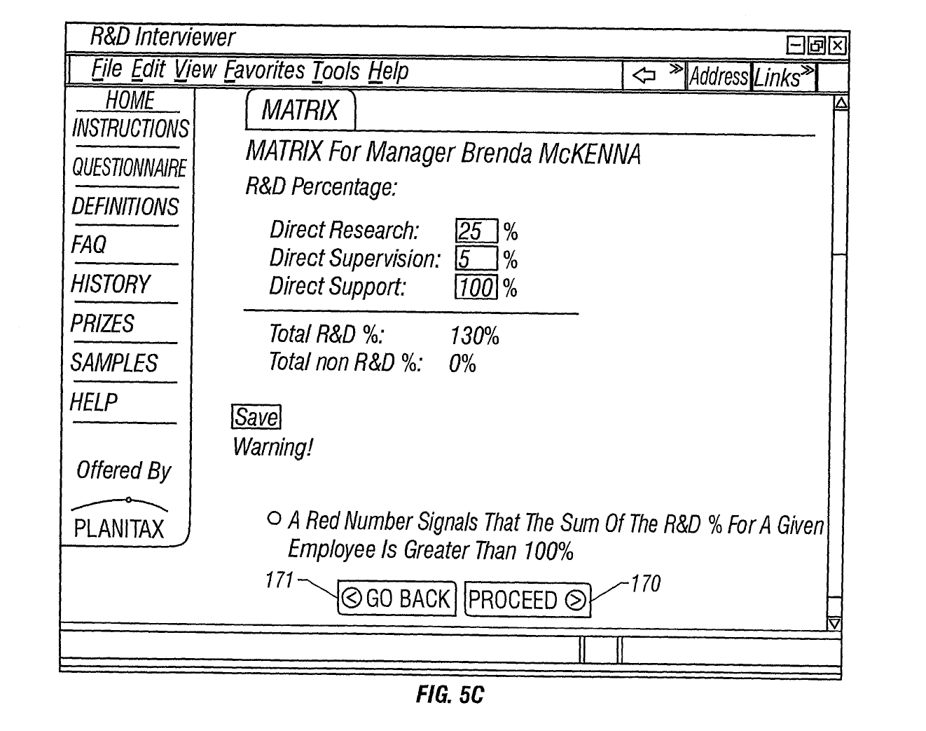

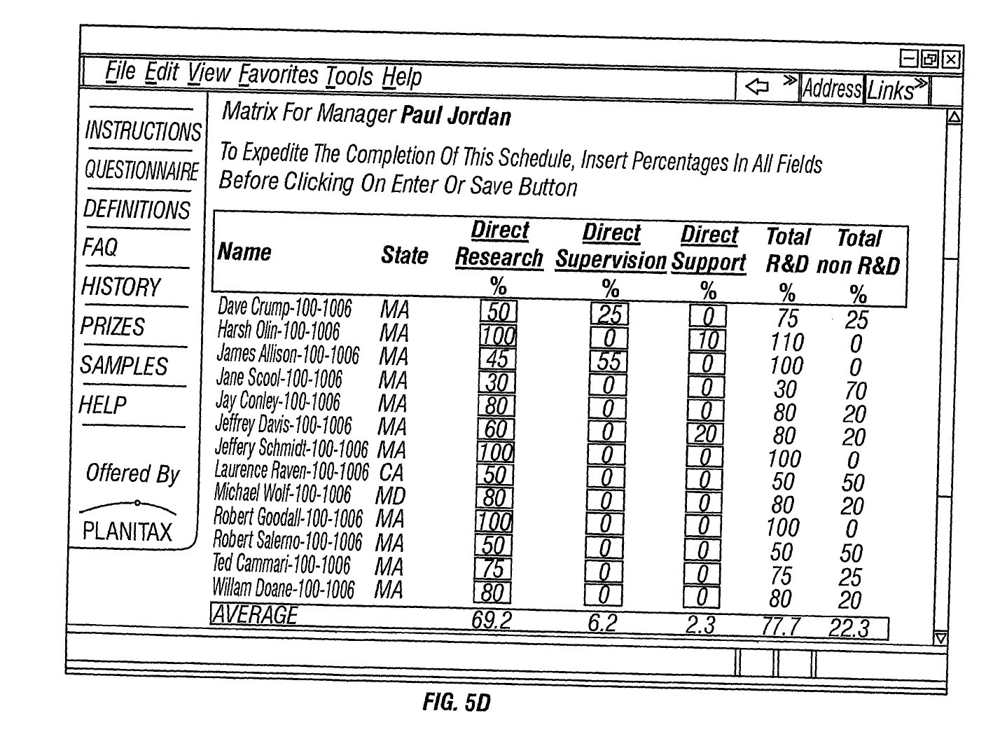

As used herein “matrix” refers to an array of one dimension or more of related data derived from the interviewing process. For example, for an individual contributor in an R&D position in a company, a personal matrix can be as simple as a one dimensional list of percentages of time spent on particular R&D activities (e.g. research, supervision, support). A matrix can also have a more complex structure, to provide more complex arrangements of interrelated data. For example, a departmental manager may have a matrix which is formed by arranging the one dimensional matrixes of a number of interviewees into a two dimensional matrix for his department. Additional information, such as departmental averages, can be derived from such department-level matrixes. FIGS. 5c and 5d illustrate two types of matrix reports for a non manager interviewee and a manger interviewee and are further described below.

In the current example, the interviews are conducted in conjunction with a Research and Development (R&D) tax credit documentation and calculations. The administrator may be able to compute the correct amount of tax credit by importing the data into a spreadsheet or by using a separate calculator module 38 (which may include a spreadsheet or a more sophisticated analysis tool). In one embodiment of the present invention, the administrator can perform “what if” scenarios by selectively changing the data and observing the results. In this way, the system can indicate how personnel and resources can be deployed to maximize the amount of the R&D tax credit.

In the current example, different levels of administration exist allowing for different levels of clearance and access to the system. At the highest level of access, the system administrator has access to all information, and using a design tool, may create a new questionnaire. Administrator access may be limited to a lower level of clearance reserved for a distributor administrator having access to fewer features of the system. And finally, a lowest level of clearance may be set up for the user company's administrator who is actually creating reports and performing the R&D calculations. The clearance levels for administrators is typically set by the system administrator.

A user that is taking a survey is limited to only access the survey module 54. He may access and complete the survey by following the instructions and completing the questionnaire. The user would typically have access to online help as well as samples of completed questionnaires. In one embodiment of the present invention the online help may be delivered in written format or by pre-recorded voice format.

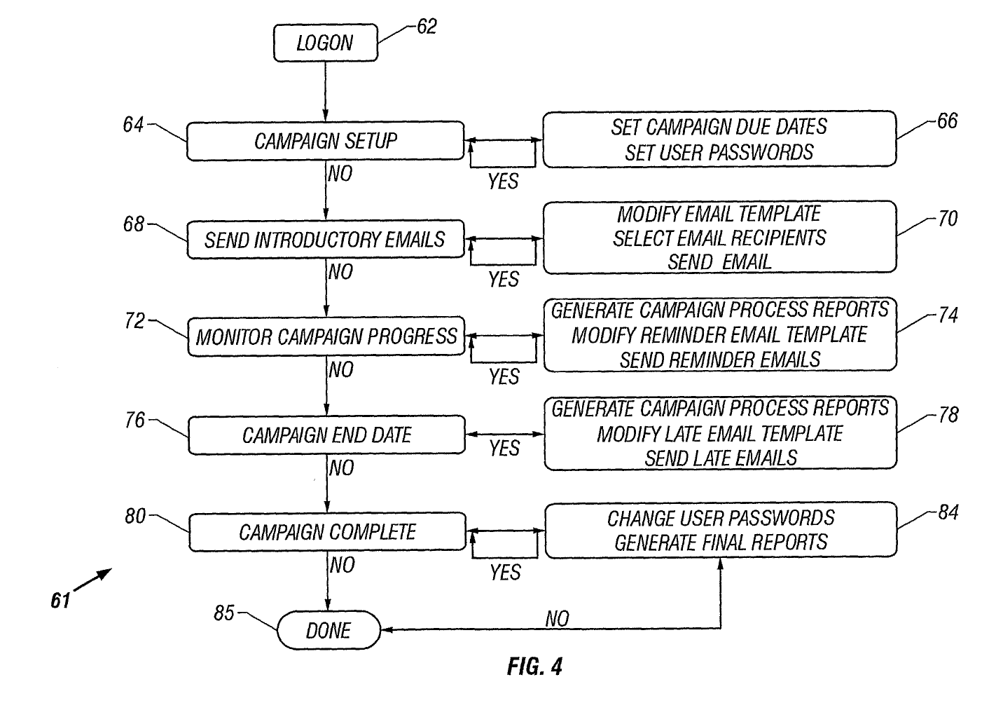

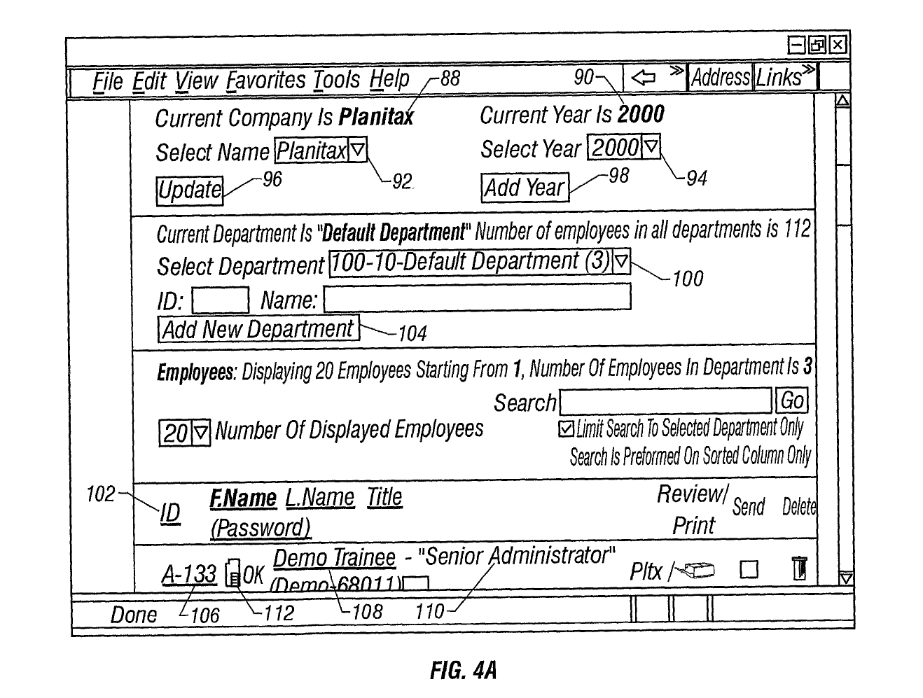

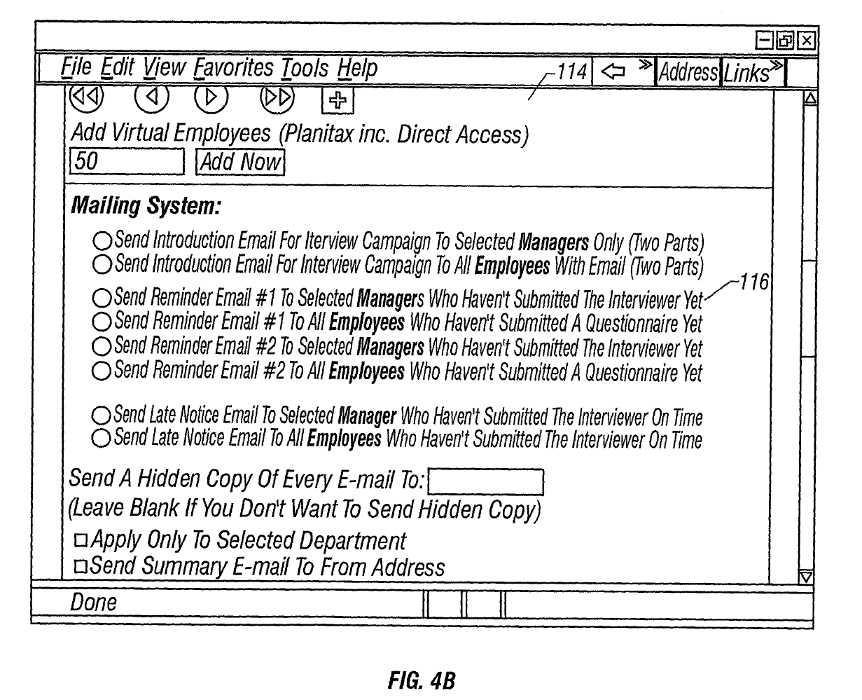

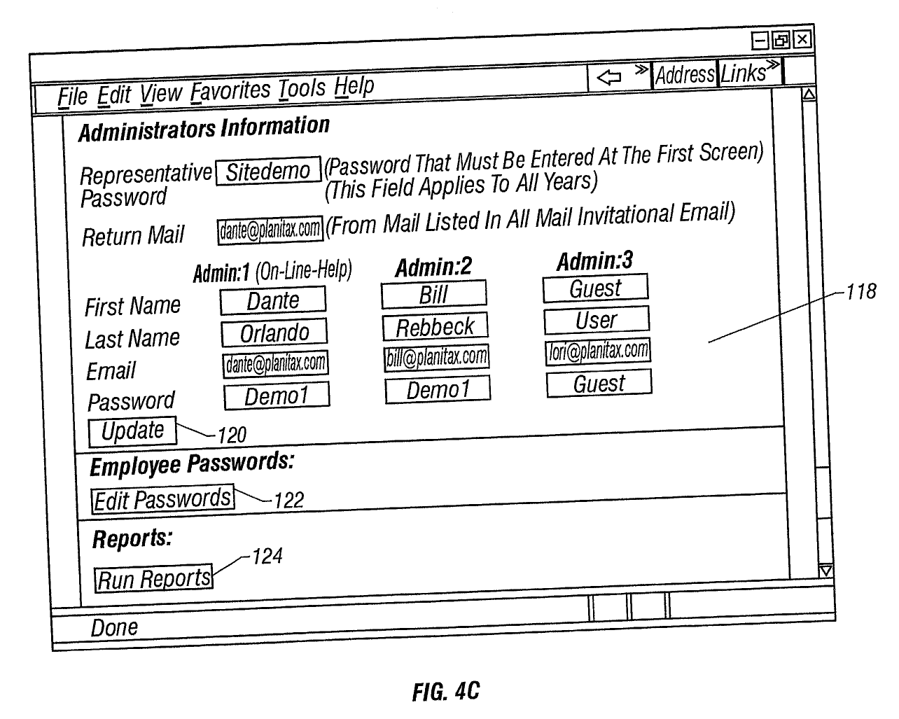

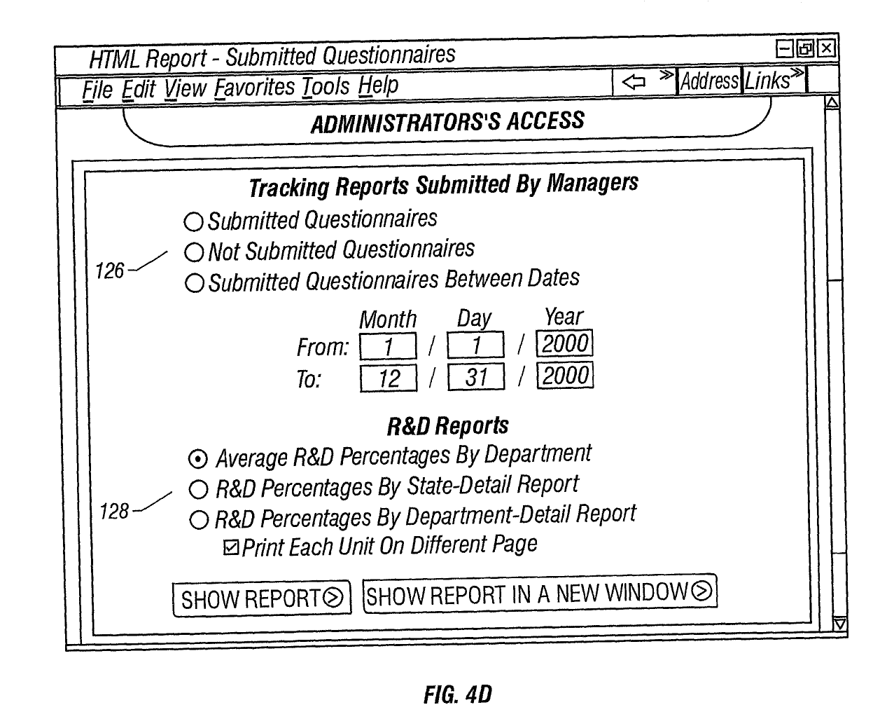

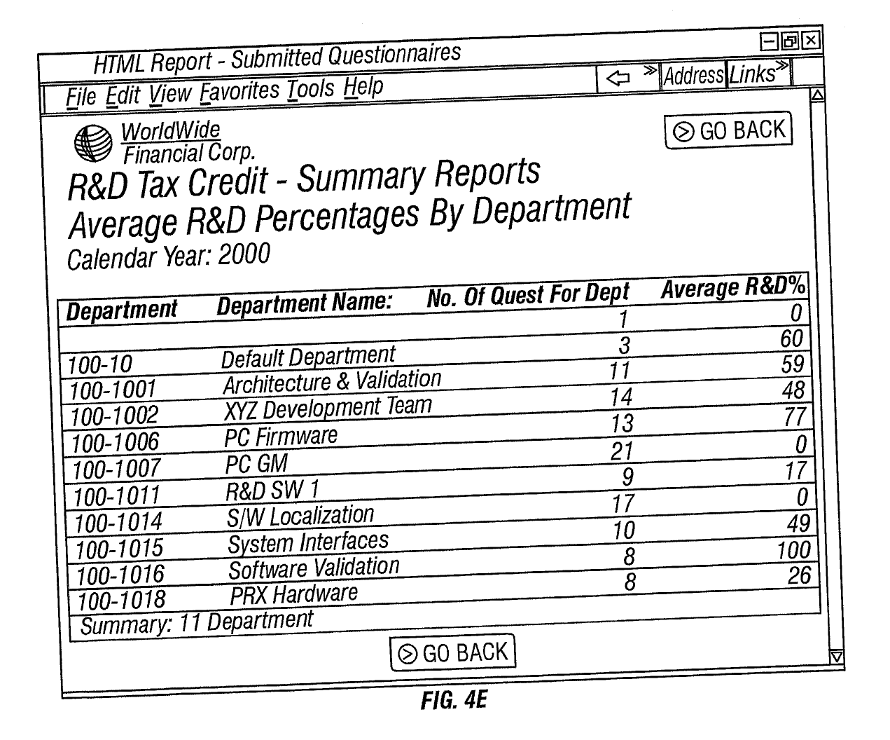

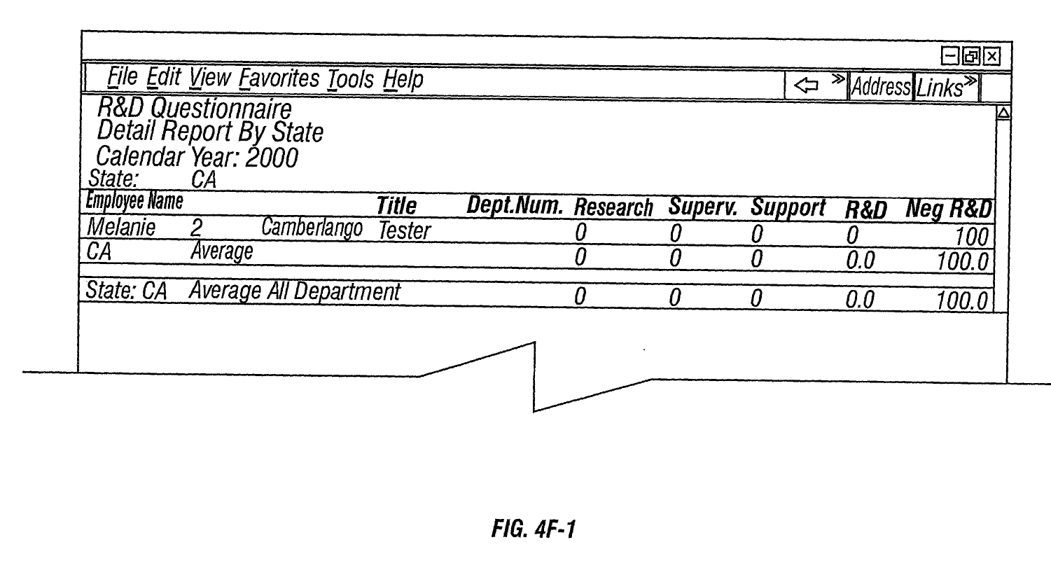

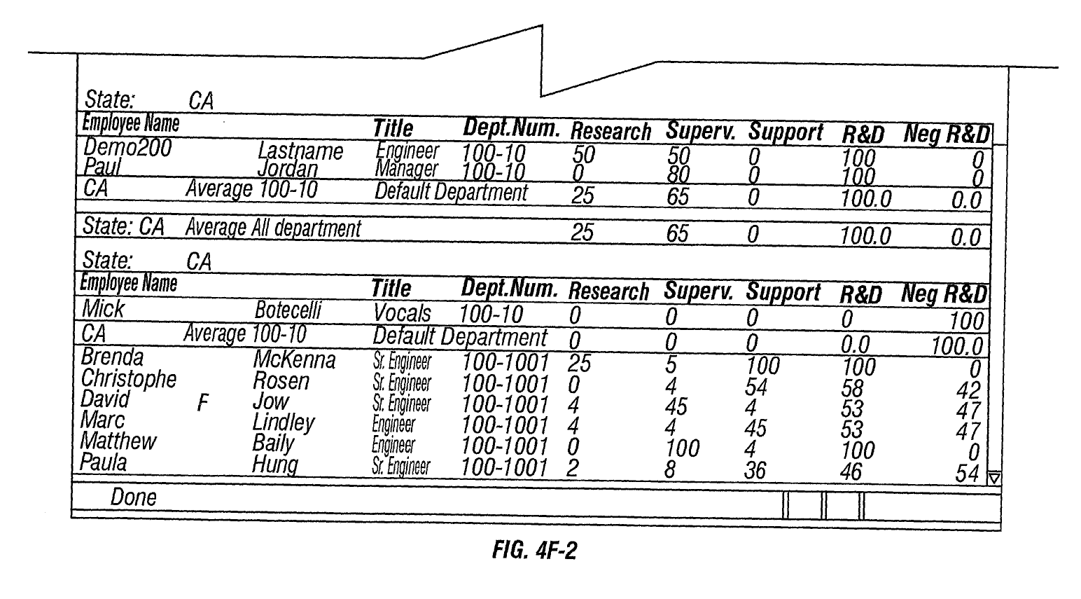

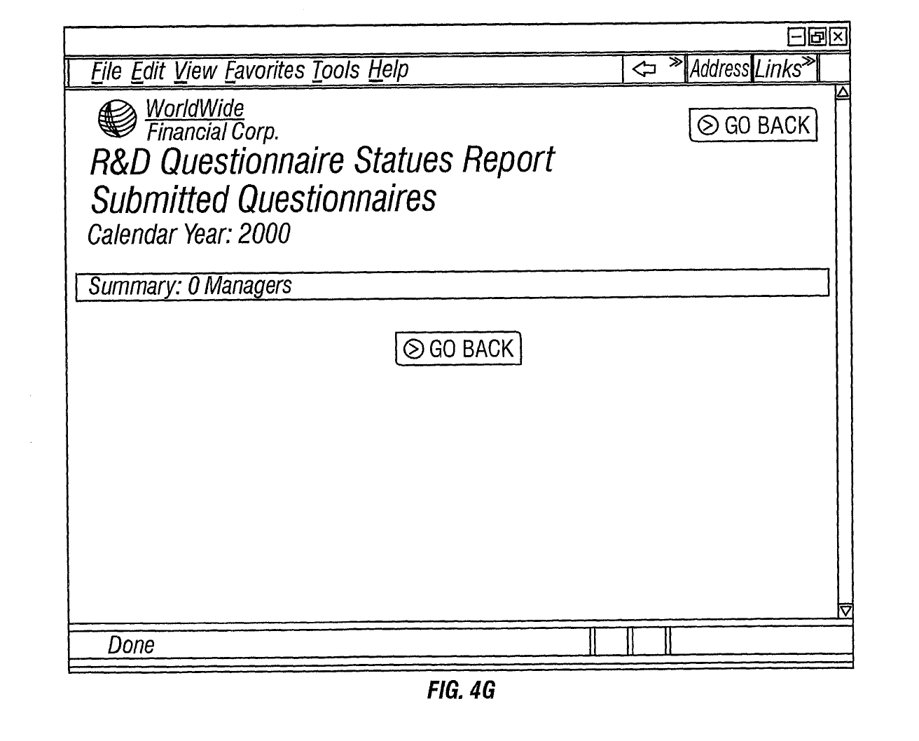

FIG. 4 is a flow chart illustrating certain activities typically within the realm of a system administrator. This system administrator function 61 begins at 62 with a log-on and user verification process. In an operation 64 it is determined if there is to be a campaign setup. If so, the campaign due dates and user passwords are set in an operation 66. In an operation 68, it is determined if introductory emails are to be sent to the interviewees. If so, operation 70 allows the modification of email templates, the selection of email recipients, and the actual sending of the emails. An operation 72 determines whether the campaign process is to be monitored. If so, an operation 74 generates a campaign process report, allows the modification of reminder email templates, and sends the reminder emails. An operation 76 determines whether the campaign has reached its end. If so, an operation 78 permits the generation of campaign process reports, allows for the modification of “late” email templates, and sends the late emails to interviewees who have not yet responded to the surveys. An operation 80 determines if the campaign is complete and, if so, an operation 84 changes the user passwords and generates the final reports. The process 61 is then complete at 85. As will be appreciated by those skilled in the art, the decision operations 64, 68, 72, 76, and 80 do not necessarily have to be processed in the order described in this example, nor do all of decisions operations be made at any one time by the system administrator.

As will be apparent to those skilled in the art, a system administrator sets up an “interview campaign” as the overall framework for accomplishing the desired task. For example, the system administrator may set up due dates such as when an R&D tax credit analysis is to be completed, when various interviewees are to have completed their survey, etc. Further, the system administrator can set interviewee passwords for each interviewee who is going to participate in the interview process.

After the administrator has set up the parameters of the interview campaign, he may use an automated email tool to send introductory emails to some or all of the interviewees. The administrator has the option of modifying one or more email templates, create his own email, select email recipients, and send emails. The actual sending of the emails is typically through email module 26 as seen in FIG. 1.

During the performance of process 61 of FIG. 4, various emails can be automatically sent. These include introductory emails to all interviewees (operation 70), first and possibly second reminder notices to interviewees who have not completed their surveys by the target date (operation 74), and a late email sent to interviewees who have not completed their surveys by the campaign end date (operation 78). The administrator may also send emails to selected employees who are not interviewees (but who should be apprised of the process) or send mass emails to all employees. He also has the option of drafting unique text for emailing.

In one embodiment of the present invention, the administrator may a report application tool (or process) 58 to generate several types of reports. Examples of such reports are tracking reports and matrix reports. That is, the report process 58 may retrieve data and further allows the administrator to select a particular report to generate.

Tracking reports allow the administrator to track interviews by notifying the administrator whether a an interviewee (sometimes referred to as “user”, “employee”, or “user-employee”) has viewed the site, has begun to complete the questionnaire (also know as a “survey”), and, if the questionnaire was completed, whether or not it contained errors. The administrator may view this data in a select time period by, for example, inputting a begin date and an end date to obtain the desired results.

Matrix reports, on the other hand, sort and process matrix data. Four types of matrix reports are available in a preferred embodiment of the present invention. One matrix report details the R&D percentages organized by departments or cost centers. Another matrix report provides a summary of the R&D percentages by department. A third matrix report sorts the data by state in detail format, and a fourth matrix report provides a summary report of the R&D data arranged by state. Again, as described above, a “matrix” is a one or more dimensional array of data derived from the interviewing and/or uploading process which presents data in an informational manner.

FIG. 4a is a “screen shot” of the administrator interface. By “screen shot” it is meant that the figure depicts the image on the screen of a user's computer, which is this case is a web page image. The name of the company 88 and the year 90 for which the R&D tax report is being prepared preferably appears on the top of the screen. A different company may be selected 92, or a different tax year 94 may be chosen and the web page is updated 96 and/or a new year is added 98 correspondingly. The administration tool allows the administrator to set up online interviews for the newly added year and store and organize historical data by year.

Different departments may be selected 100, and the corresponding list of employees in that department would appear 102. The administrator may even add new departments, and enter names of employees in that department. The administration tool allows the administrator to perform a number of functions including deciding which department and which employees will receive the Interviewer, adding, deleting or changing employees (change impact questionnaire matrix automatically) and/or change departments, inserting or changing employee data which pre-populates the questionnaire general information section, inserting password information for secured access to site by employee inserting email address for auto-email tool, viewing the questionnaire while it is being completed, by the interviewee, editing interviews, and viewing employees in a department in groups.

The names 108 of individual employees corresponding to the selected department are listed on the web page as well as their employee identification 106, and their job title 110. The letter icon 112 indicates whether that employee's Interview has been completed and received or, if it is in progress or if it was received but contains errors. Selecting the employee identification 106 would take the administrator to that employees Interview.

FIG. 4b is a screen shot of more features of the administrator web page. The buttons in 114 allow the administrator to add or delete employees from a department. The mailing system 116 offers different options for creating an automated email campaign including sending introduction emails to selected managers and/or employees, sending first and second reminder emails to managers and employees who have not submitted a questionnaire yet, and sending late notice emails to employees and managers who have not submitted their questionnaire on time. The email system may include other options such as sending hidden emails to selected persons such as a department head or a financial manager.

FIG. 4c is a screen shot of the last portion of the administrator web page. Area 118 lists the administrators having administrative privileges. The data in the data fields for first name, last name, email and password may be updated using the Update button 120. Alternatively, when one administrator logs on, the data fields corresponding to the information of other administrators may appear as blank, protecting the privacy of the data such as password for each administrator Administrators may change employee passwords by selecting the “Edit passwords” button 122. An administrator may generate reports using the report application tool by selecting the “Run reports button” 124. The reports option would include tracking reports showing the progress of the completion of the interview campaign as well as data summary report based on the interviewees response data entered in response to the questionnaires. The reporting tool and the business logic 24 organize and manipulate the raw data generated from the questionnaires, and processes them into a format suitable for reports as well as for use in calculating the R&D tax credit.

FIG. 4d is a screen shot of the user interface for selecting options for tracking reports and R&D reports. The tracking report generation options 126 gives the administrator several options of the type of tracking report generated. The administrator can generate a report tracking the submitted questionnaires, the not submitted questionnaires or the submitted questionnaires between certain dates. Furthermore, an administrator may use the R&D report generating options 128 in summarizing the Interview data. The report generating tool may create a average R&D report divided by department showing the average R&D activities as a percentage of all activities. Alternatively, the administrator may generate reports organized by state or by department, detailing the R&D activities.

FIG. 4e is a screen shot of the user interface displaying a summary R&D report organized by department. The administrator can monitor the accuracy of the interview campaign by accessing the individual questionnaires and by creating various reports compiled from the questionnaires. By selecting the average R&D tax credit report from the R&D report options 128, the administrator may obtain a summary report organized by department, of the total R&D activities for the selected year. An exemplary report as shown in FIG. 4e may include the department numbers, the corresponding department names, number of questionnaires completed for each department and the average R&D activities in terms of the a percent of the total activities in that department. The administrator may use this information to analyze the accuracy of the responses to the questionnaire.

FIG. 4f is a screen shot of the user interface displaying a detail R&D report organized by state. In this example, the data from the questionnaires for each department is tabulated and organized by in detail by the state. The data is listed per employee and per state in which the activities occurred. The report also may show details of the activities involved such as research, supervision or support, or non R&D activities. Again these totals may be expressed in terms of the percentage of the total activities performed by each employee.

FIG. 4g is a screen shot of the user interface displaying an R&D Questionnaire status report. The administrator may monitor the progress of the completion of the questionnaires by creating tracking report that would present in detail the number of questionnaires completed, those partially completed and those not completed at all. Using this information the administrator may select to send to those who are not complying with the deadline of the interview campaign a first or second late notice email. The same report may be used to identify the submitted reports that have errors and require corrections. The administrator may also use this report to identify the candidates for receiving prizes because of their timely completion of their questionnaire, if such a prize or contest exists.

FIG. 5 illustrates a flow chart of the activities or process 129 of the user through the interview process. Once the user(interviewee) logon is completed in operation 130, the user begins to complete the questionnaire in operation 132. A tool is provided to the user so that he may attach any supporting document necessary, while he is completing the questionnaire. The term user as used here refers to the interviewees logging on to the system to complete the questionnaire. Although, administrators may access the questionnaire as well, they are not referred to as users here. A matrix derived from the survey data is displayed to the user at a decision operation 134 and the interviewee is allowed to return to the operation 132 and complete any missing or incorrect information of the questionnaire. Once the user is satisfied with his results, he may submit his completed questionnaire and matrix in an operation 136.

FIG. 5a is a screen shot of the start of the Interviewer web page and the beginning of the questionnaire. After the user inputs his first name 138 and his assigned password 140, he may proceed to the Interview by clicking on the proceed button 142. As shown on left hand side of the screen in FIG. 5a, the user may select from a menu 144 one of several options. The user may select to return to the home page 146, or get instructions on how to complete the interview by selecting the Instructions option 148.

By selecting the questionnaire option 150, the user may get to the web page of the questionnaire. Some of the fields in the questionnaire may be pre-populated by general information and data extracted from the administrator employee general information tool. For example, the company name, address, or the users information may be automatically inserted into the questionnaire to “pre-populate” the general information area of questionnaire. The terms pre-populate as used here refers to importing data from outside of the questionnaire to automatically complete some of the data fields in the questionnaire. For example, an employees first name, last name, title, email, department name, and department number may be automatically completed in each questionnaire for that particular user.

The definitions option 152 links to a page where the users/employees can get more information on terminology used in the questionnaire, understanding the matrix reports or using attachments pages. The FAQ option 154 responds to “Frequently Asked Questions” by users. This may include customized data by the company such as contact information, and email notification links. The history option 156 displays a text data discussing the history of R&D tax credit. The prizes option 158 allows the companies to create incentives for interviewees to complete the interview promptly, e.g. a “contest” for early, complete, and accurate completion of the questionnaires. As an example, this page may contain text explaining the contest or and may contain the current state of submitted questionnaire data by selected groups. In the present example of collecting R&D tax credit data, timely completion of the questionnaire may be crucial because of governmental deadlines, and therefore offering prizes may be a crucial incentive to help complete the questionnaire in timely fashion. The samples option 160 links to a web page where samples of completed questionnaires may be seen. The help option 162 opens an automatic email pop up box, addressed to the company administrator for this department.

The general information field 164 may be pre-populated automatically using existing company information. These pre-populated fields may include employees first and last names, email address, department name and number and the employee identification number. The text 166 reminds the user of the due date for the submission of the questionnaire. Part I of the questionnaire 168 starts by asking questions about general R&D activities. Part II may ask more detail questions about the R&D activities. Part III may relate to internal-use software, part IV to R&D support activities, part V to other miscellaneous questions and part VI to non-qualifying activities. The user may save his entries after completing each part.

FIG. 5b is a screen shot of an ending portion of an exemplary questionnaire. Once users have completed their questionnaires, they may proceed to the next step by selecting the proceed button 170.

FIG. 5c is a screen shot of the user interface showing a matrix for an employee interviewee, i.e. an interviewee who is not a department manager and completes the questionnaire on his own behalf only. In contrast, a department manager may complete a questionnaire for his entire department. This questionnaire would include inquiries into the activities of individual employees in his department. Alternatively, the department manager may only complete a personal questionnaire referring only to his activities and not to the activities of the department as a whole.

Selecting the proceed button 170 takes the user to the next web page where the user may submit her Questionnaire. If there is any problems with the questionnaire, the interviewee may “go back” 171 or return to the questionnaire and correct his/her responses to the questionnaire.

FIG. 5d is a screen shot of the user interface showing the matrix for a user who is a department manager, i.e. who has management responsibilities over a number of contributors. In this page, the result of the data compiled for each employee of the department regarding their R&D activities gathered using the questionnaire is shown. The matrix data is determined in the administrator tool section, where the administrator may add or delete an employee to a department. The matrix data is extracted from the Reports tool. Percentages are subtotaled and averaged by department, and invalid entries are earmarked, such as percentages exceeding one hundred percent. If the results displayed in the matrix are satisfactory, the user may proceed to the end of the questionnaire by selecting the proceed button 170 not shown here.

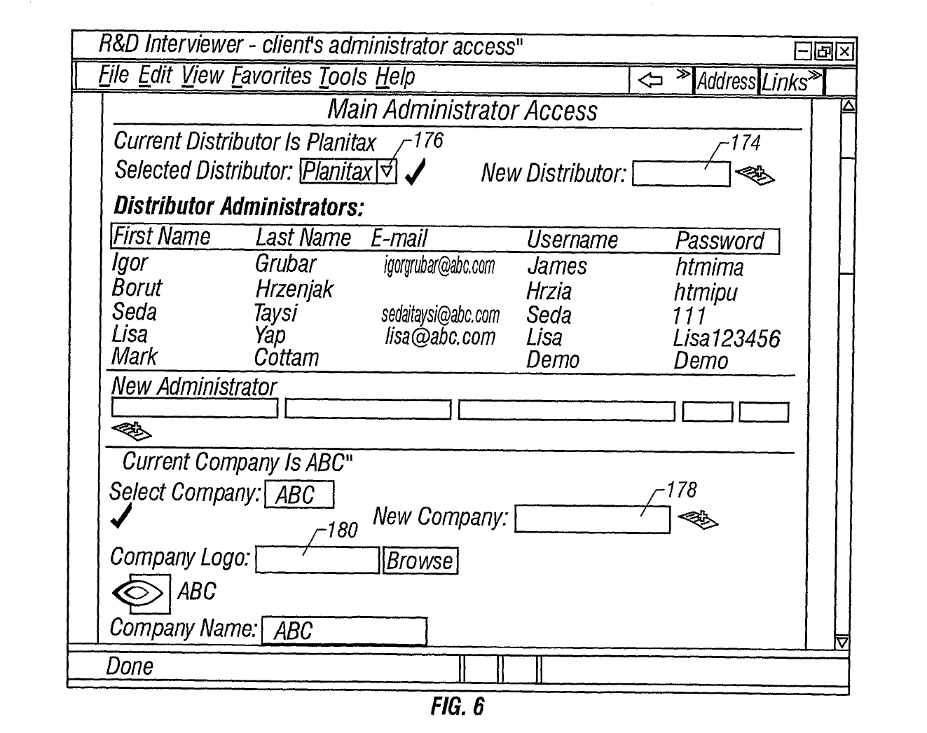

FIG. 6 is a screen shot of the administrator interface at the highest administrator level. In an alternative embodiment of the present invention, the Interviewer may licensed for use to a user company using an intermediary distributor. The distributor's administrators would have greater clearance and access to the system as in contrast to the interview campaign administrator of the user company. As an example, the user companies administrator may not create an interview questionnaire, whereas the distributor administrator or the administrators of the company licensing the Interviewer system may create questionnaires. The highest administration level of clearance allows creator of the interview tool to add distributors 174 or select an existing distributor 176 and get a listing of all of that distributor's administrators. Administrators of the company licensing the Interviewer system may add or remove user companies from a distributor's list of clients by using the new company field 178. User company logos may be created and used with all the web sites for that company 180.

Although the present invention has been described above with respect to presently preferred embodiments it being understood that various equivalents, alterations and modifications thereof will become apparent to those skilled in the art. It is therefore intended that the appended claims to be interpreted as covering all such alterations and modifications as fall within the true spirit and scope of the invention.

What is claimed is:

1. A method of conducting a network-based interview comprising:
creating at least one online questionnaire residing on a web site wherein access to said web site is protected by at least an interviewee specific password;
providing automated email tools for creating email templates and generating an automated email campaign and sending at least one of an introductory email, a first and a second reminder email, and a late notice email;
providing management tools for managing and tracking the progress of the completion of said questionnaire by each interviewee;
providing data management tools for determining and documenting response data collected from said online questionnaires; and
providing reporting tools for generating reports based on the data collected from said online questionnaires.

2. An apparatus for conducting an online interview campaign comprising:
a web server capable of generating web pages and allowing at least one administrator and at least one user to connect to an application server over a global network;
an application server hosting a business logic capable of generating online questionnaires residing on web sites hosted by said web server, and providing tools allowing said administrator to organize and manipulate data generated from said user's responses to said online questionnaires whereby said data generated from said user's responses are used in determining and documenting tax data;
a database for storing said tax data generated from said online questionnaires.

4. A network-based method for determining and documenting tax data comprising:
creating at least one online questionnaire residing on a web site and wherein access to said web site is protected by at least an interviewee specific password;
providing management tools to an administrator managing said online questionnaire process wherein said management tools includes at least one of
providing a tracking tool allowing the administrator to track the progress of the completion of said questionnaire by each interviewee,
providing an email management tool allowing the administrator to generate an email campaign related to the online questionnaire, and
providing a report generation tool allowing the administrator to generate tracking reports; and
providing data organization tools allowing the administrator to document and determine tax data based on the response data collected from interviewee questionnaire.

5. A computerized network-based method comprising:
obtaining tax data using at least one online questionnaire residing on a password protected web site;
providing administration tools for organizing and documenting said tax data;
providing report generating tools; and
using said report generating tool and said tax data to generate reports used in documenting and determining tax credit.

6. A computerized network-based method as recited in claim 5 wherein said tax data is R&D tax credit data.

7. A computerized network-based method as recited in claim 5 further comprising:
establishing contest criteria for potential interviewees; and
awarding contest awards to one or more potential interviewees based upon their performance relative to said contest criteria.

8. A computerized network-based method as recited in claim 5 further comprising:
providing a tool to an administrator for setting up interviews each year; and
storing historical data by year for each year.

9. A computerized network-based method as recited in claim 5 further comprising:
providing an employee and department management tool to an administrator whereby said tool allows the administrator to decide which department and which employee will be interviewed.

10. A computerized network-based method as recited in claim 5 further comprising:
providing a tool to an administrator to perform at least one of add, delete and change employees and departments.

11. A computerized network-based method as recited in claim 5 further comprising:
providing a tool to pre-populated data in said questionnaires general information section.

12. A computerized network-based method as recited in claim 5 further comprising:
providing a tool to insert password information for secured access to site by users.

13. A computerized network-based method as recited in claim 5 further comprising:
providing a tool to insert email address for automatic email.

14. A computerized network-based method as recited in claim 5 further comprising:
providing a tool to an administrator to view a questionnaire while its being completed by those being interviewed.

15. A computerized network-based method as recited in claim 5 further comprising:
providing a tool to an administrator to edit a questionnaire.

16. A computerized network-based method as recited in claim 5 further comprising:
providing a tool to an administrator for viewing employees in a department in groups.

17. A computerized network-based method as recited in claim 5 further comprising:
providing a tool to automate an email system whereby the administrator may setup said system to automatically send at least one of: introduction email, a first reminder notice, a second reminder notice, and a late notice.

18. A computerized network-based method as recited in claim 5 further comprising:
providing a report application tool to an administrator, whereby the administrator may generate a tracking report of the completion of questionnaires; and
providing a matrix reporting tool to an administrator, whereby the interviewee may access the results of his responses to said questionnaire and correct for any errors.

19. A computerized network-based method as recited in claim 5 further comprising:
providing a security tool to an administrator wherein access to the web site is by using at least one of limiting access using IP addresses and limiting access by assigning interviewee specific passwords.

20. A computerized network-based method as recited in claim 5 further comprising:
providing a tool to enable the administrator to view who has access to their site.

21. A computerized network-based method as recited in claim 5 further comprising:
providing interviewees help options by providing at least one of:
instructions, history, prizes, definitions, FAQ, samples and help.

22. A computerized network-based method as recited in claim 21 further comprising:
providing said interviewees a tool to attach supporting documents with their responses to said questionnaire.
